(19) United States
(12) Patent Application Publication
(10) Pub. No.: US 2016/0303785 A1
(43) Pub. Date: Oct. 20, 2016

(54) ADJUSTABLE STROKE CENTERING LINKAGE MECHANISM FOR STACK MOULD

(71) Applicant: Alexander Segal, Richmond Hill (CA)

(72) Inventor: Alexander Segal, Richmond Hill (CA)

(21) Appl. No.: 15/099,734

(22) Filed: Apr. 15, 2016

Related U.S. Application Data
(60) Provisional application No. 62/148,717, filed on Apr. 16, 2015.

(51) Int. Cl. B29C 45/66

(52) U.S. Cl. CPC B29C 45/661; B29L 2031/757

(57) ABSTRACT

An injection moulding machine that incorporates a centering linkage for producing unequal strokes during the opening and closing of the mould sections. The centering linkage mechanism is adjustable so that the stroke lengths of the mould sections can be adjusted from time to time

### CROSS-REFERENCE

This application claims priority to U.S. Provisional App. No. 62/148,717 filed Apr. 16, 2015.

### FIELD

The subject matter hereof relates generally to the field of injection moulding machines.

### BACKGROUND

An example of a moulding machine having a centering linkage that enables unequal strokes of the mould sections is disclosed in U.S. Pat. No. 6,099,784 to Husky Injection Moulding Systems. The issue with the mechanisms described in this reference is that the centering linkage mechanism is not easily adjustable. A more robust solution is desired.

### SUMMARY OF INVENTION

In one aspect of the invention an injection moulding machine is provided that incorporates a centering linkage for producing unequal strokes during the opening and closing of the mould sections. The centering linkage mechanism is adjustable so that the stroke lengths of the mould sections can be adjusted from time to time.

According to this aspect, there is provided an injection moulding machine which includes a stationary platen with a mould plate and a moveable platen with a mould plate. A primary drive axially reciprocates the moving platen between an open position and a closed position. The machine further includes at least one moveable center section having first and second mould plates on opposing sides thereof, the first mould plate facing the stationary platen mould plate so as to define a first mould half, the second mould plate facing the moving platen mould plate so as to define a second mould half. A centering linkage mechanism converts the reciprocating movement of the moveable platen to corresponding reciprocating movement of the center section. The centering linkage mechanism includes a central link member pivotally connected to the center section, a first link arm pivotally connected to the central link member and pivotally connected to the stationary platen, and a second link arm pivotally connected to the central link member and pivotally connected to the moving platen. At least one of the first link arm and the second link arm includes a central piece that is threadingly engaged with two end pieces such that the depth of engagement between the center piece and each end piece is manually adjustable, thereby enabling adjustment in stroke length of at least one of the mould halves.

### BRIEF DESCRIPTION OF DRAWINGS

The foregoing and other aspects of the invention will be more readily appreciated having reference to the attached drawings wherein:

FIG. 1 shows a portion of a stack mould, including centering linkage according to a first embodiment of the invention, in an open position;

FIG. 2 shows the portion of the stack mould of FIG. 1 in a closed position; and

FIGS. 3A, 3B and 3C shows elevation, plan and cross-section views of a portion of the centering linkage.

### DETAILED DESCRIPTION

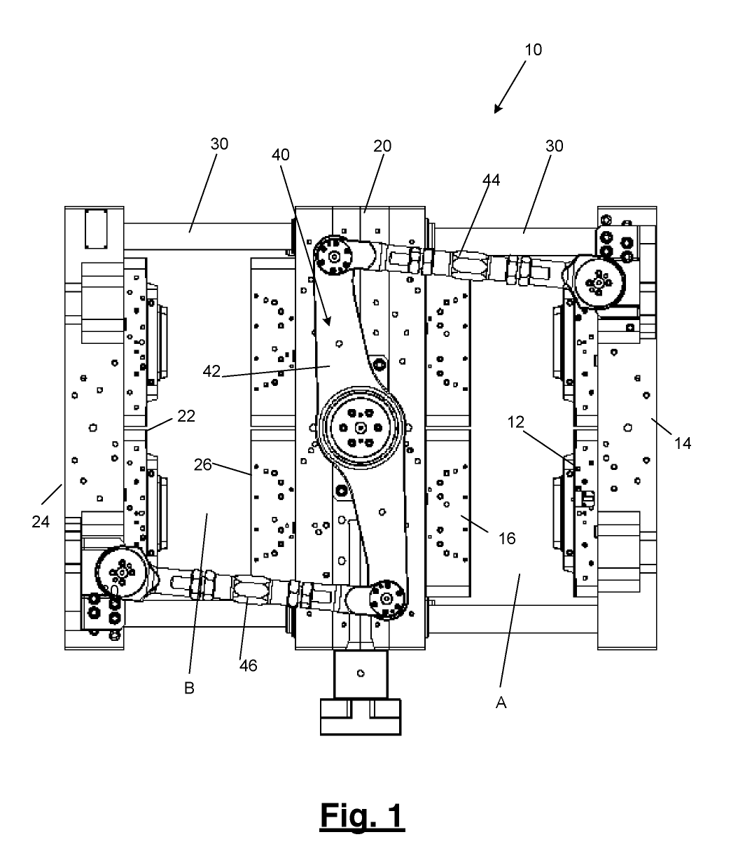

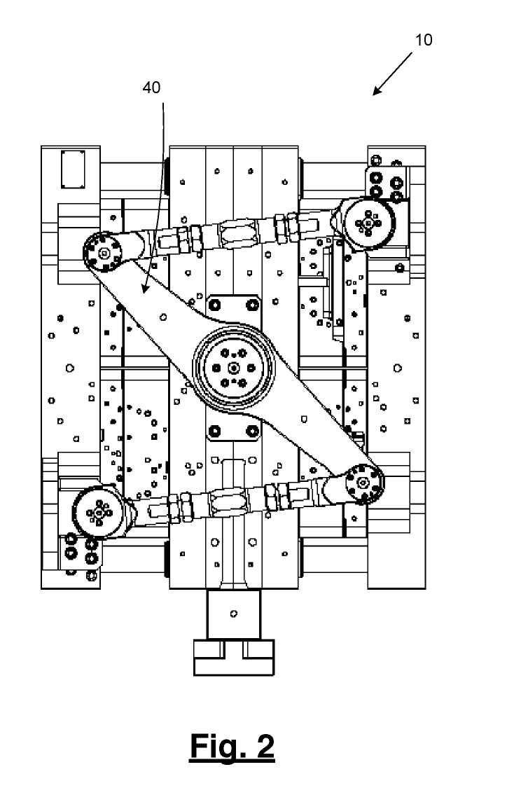

FIGS. 1 and 2 show a portion of a stack mould 10, which has two moulding stations A and B. Station A is provided by a mould plate 12 mounted on a stationary platen 14 and a mould plate 16 mounted on a immediately adjacent side of a center section 20. When juxtaposed or closed together these two mould plates 12, 16 define a first set of mould cavity spaces into which molten material is injected. Likewise, Station B is provided by a mould plate 22 mounted on a moving platen 24 and a mould plate 26 mounted on the immediately adjacent side of the center section 20. When juxtaposed or closed together these two mould plates 22, 26 define a second set of mould cavity spaces into which molten material is injected.

The mould sections are mounted on and translate over tie bars 30. The primary drive means for moving the mould sections is not shown as it is a conventional mechanism.

As the moving platen 24 reciprocates between open and closed positions to open and close the mould, the center section 20 must also move relative to the stationary and moving platens 14, 24 in order to open the stations A and B for ejection or removal of the moulded articles. In particular, in a balanced or symmetrical mould the center section 20 moves half the distance or half the stroke of the moving platen 24, relative to the stationary platen 14, so the opening width of stations A and B are equal. In some circumstances, for example, where stations A and B mould articles of different sizes, it may be desirable for the center section 20 to have a different stroke ratio so that the opening widths of stations A and B are different.

The stack mould 10 is provided with a centering linkage mechanism 40 to cause the mould stations A and B to have different or unequal opening strokes. The linkage mechanism 40 includes a central link member 42 pivotally connected to the center section 20, a first link arm 44 which is pivotally connected at one end to the central link member 42 and pivotally connected at the other end to the stationary platen 14, and a second link arm 46 which is pivotally connected at one end to the central link member 42 and pivotally connected at the other end to the moving platen 24.

The first and second link arms 44, 46 may have different lengths, whereby mould stations A and B may have different or unequal opening strokes.

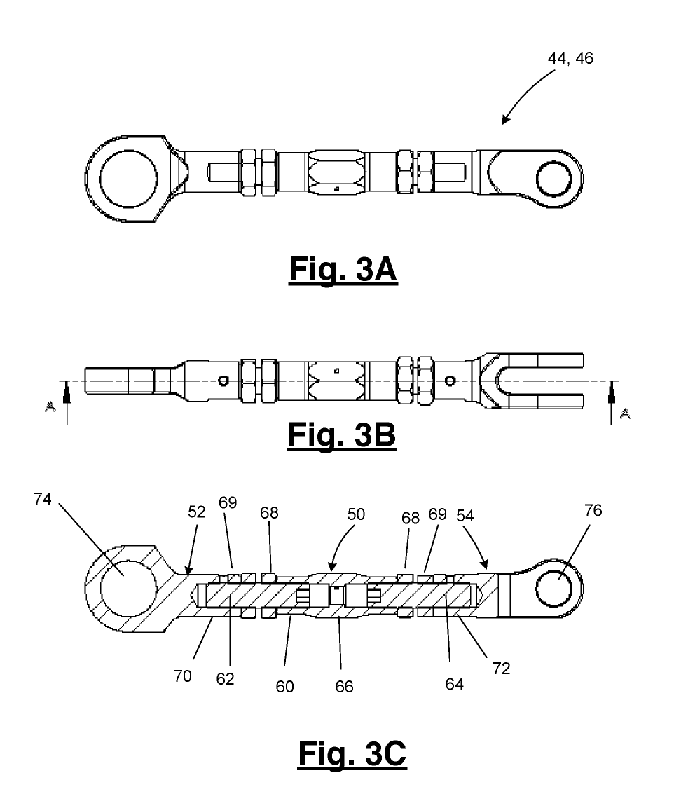

The link arms 44, 46 may be identically constructed and FIGS. 3A, 3B and 3C show various views of one link arm. The link arm 44 or 46 is preferably constructed from three parts: a center piece 50 and two end pieces 52, 54. The link arm 44 or 46 is adjustable in length because the center piece 50 is threadingly engaged with the end pieces 52, 54 such that the depth of engagement between the center piece 50 and each end piece 52, 54 can be manually adjusted.

In the illustrated embodiment the center piece 50 has two opposing threaded shafts 62, 64 which jut out from opposites ends of a casing 60. In practice the casing 60 can be provided by an internally threaded cylinder which has a centrally situated tooling profile 66 on the outer surface thereof for receipt of a gripping tool head such as a wrench. The threaded shafts 62, 64 may be releasably locked in position by lock nuts 68. The end pieces 52, 54 each include threaded apertures 70, 72, respectively, for receipt of the threaded shafts 62, 64. The end pieces 52, 54 may be releasably locked against the threaded shafts 62, 64 by lock nuts 69.

Loosening the lock nuts 68, 69 allows the operator to adjust depth of engagement of the threaded shafts 62, 64 within the end pieces 52, 54, thus enabling adjustment of the mould station stroke distance.

The opposite end of the end pieces 50, 52 include apertures 74, 76, respectively, for pivotal connection to the central link member and moving or stationary platen. As the end pieces 52, 54 are precluded from rotating, rotation of the center piece 50 will cause a corresponding translation of the end pieces 52, 54 relative to the center piece 50. The orientation of the shaft threads 62, 64 and threaded apertures 70,72 can be arranged such that rotation of the center piece 50 in one direction causes the end pieces 52, 54 to simultaneously move away from one another and rotation of the center piece 50 in the opposite direction causes the end pieces 52, 54 to simultaneously move toward one another.

Those skilled in the art will appreciate that a variety of other alternations or modifications may be made to the embodiments discussed herein without departing from the scope of the invention as defined by the appended claims.

1. An injection moulding machine, including:
a stationary platen with a mould plate;
a moveable platen with a mould plate;
a primary drive for axially reciprocating the moving platen between an open position and a closed position;
at least one moveable center section having first and second mould plates on opposing sides thereof, the first mould plate facing the stationary platen mould plate so as to define a first mould half, the second mould plate facing the moving platen mould plate so as to define a second mould half;
a centering linkage mechanism for converting the reciprocating movement of the moveable platen to corresponding reciprocating movement of the center section, the centering linkage mechanism having a central link member pivotally connected to the center section, a first link arm pivotally connected to the central link member and pivotally connected to the stationary platen, and a second link arm pivotally connected to the central link member and pivotally connected to the moving platen;
wherein at least one of the first link arm and the second link arm includes a central piece that is threadingly engaged with two end pieces such that the depth of engagement between the center piece and each end piece is manually adjustable, thereby enabling adjustment in stroke length of at least one of the mould halves.

2. A machine according to claim 1, wherein the center piece includes a casing and has two opposing threaded shafts which extend from opposite ends of the casing.

3. A machine according to claim 2, wherein each end piece includes a threaded aperture for receipt of one of the threaded shafts.

4. A machine according to claim 3, wherein each end piece includes an aperture for pivotal connection to one of the central link member, moving platen or stationary platen.

5. A machine according to claim 1, wherein the center piece comprises:
a cylinder having an inner surface and an outer surface, the outer surface being profiled to mate with a tool head, the inner surface being threaded;
first and second threaded shafts, each threaded shaft disposed in threading engagement with the threaded cylinder inner surface; and
first lock nuts for releasably locking the threaded shafts against the casing.

6. A machine according to claim 5, wherein:
each end piece has opposing ends, one end having a threaded aperture for receipt of one of the threaded shafts, the other end having an aperture pivotal connected to one of the central link member, moving platen and stationary platen;
the end pieces include second lock nuts for releasably locking the threaded shafts against the end pieces;
whereby, when the first and second lock nuts are loosened, rotation of the center piece causes a corresponding translation of the end pieces relative to the center piece.

7. A machine according to claim 6, wherein the orientation of the shaft threads and threaded apertures are arranged such that rotation of the center piece in one direction causes the end pieces to simultaneously move away from one another and rotation of the center piece in the opposite direction causes the end pieces to simultaneously move toward one another.

8. A link arm for an injection moulding machine, said injection moulding machine including a stationary platen with a mould plate; a moveable platen with a mould plate; a primary drive for axially reciprocating the moving platen between an open position and a closed position; at least one moveable center section having first and second mould plates on opposing sides thereof, the first mould plate facing the stationary platen mould plate so as to define a first mould half, the second mould plate facing the moving platen mould plate so as to define a second mould half; and a centering linkage mechanism for converting the reciprocating movement of the moveable platen to corresponding reciprocating movement of the center section, the centering linkage mechanism having a central link member pivotally connected to the center section, a first link arm pivotally connected to the central link member and pivotally connected to the stationary platen, and a second link arm pivotally connected to the central link member and pivotally connected to the moving platen;
wherein each said link arm includes a central piece that is threadingly engaged with two end pieces such that the depth of engagement between the center piece and each end piece is manually adjustable, thereby enabling adjustment in stroke length of at least one of the mould halves.

9. A link arm according to claim 8, wherein the center piece includes a casing and has two opposing threaded shafts which extend from opposite ends of the casing.

10. A link arm according to claim 9, wherein each end piece includes a threaded aperture for receipt of one of the threaded shafts.

11. A link arm according to claim 10, wherein each end piece includes an aperture for pivotal connection to one of the central link member, moving platen or stationary platen.

12. A link arm according to claim 8, wherein the center piece comprises:
a cylinder having an inner surface and an outer surface, the outer surface being profiled to mate with a tool head, the inner surface being threaded;
first and second threaded shafts, each threaded shaft disposed in threading engagement with the threaded cylinder inner surface; and
first lock nuts for releasably locking the threaded shafts against the casing.

13. A link arm according to claim 12, wherein:
each end piece has opposing ends, one end having a threaded aperture for receipt of one of the threaded shafts, the other end having an aperture pivotal connected to one of the central link member, moving platen and stationary platen;
the end pieces include second lock nuts for releasably locking the threaded shafts against the end pieces;
whereby, when the first and second lock nuts are loosened, rotation of the center piece causes a corresponding translation of the end pieces relative to the center piece.

14. A link arm according to claim 13, wherein the orientation of the shaft threads and threaded apertures are arranged such that rotation of the center piece in one direction causes the end pieces to simultaneously move away from one another and rotation of the center piece in the opposite direction causes the end pieces to simultaneously move toward one another.
